(19) United States
(12) Patent Application Publication
(10) Pub. No.: US 2018/0093859 A1
(43) Pub. Date: Apr. 5, 2018

(54) OCCUPANT EVACUATION OPERATION BY ALLOCATING A VARIABLE NUMBER OF CARS TO FLOORS WITHIN AN EVACUATION ZONE

(71) Applicant: Otis Elevator Company, Farmington, CT (US)

(72) Inventors: Paul A. Stranieri, Bristol, CT (US); Ronnie E. Thebeau, Haddam, CT (US); James M. Collins, Burlington, CT (US); David M. Hughes, East Hampton, CT (US); Jannah A. Stanley, Portland, CT (US)

(21) Appl. No.: 15/282,125

(22) Filed: Sep. 30, 2016

(51) Int. Cl. B66B 5/02; B66B 1/28; B66B 1/24

(52) U.S. Cl. CPC B66B 5/021; B66B 9/00; B66B 1/2408; B66B 1/28

(57) ABSTRACT

A method of operating an elevator building system is provided. The method includes: receiving an evacuation call from a first evacuation floor; determining an evacuation zone surrounding the first evacuation floor; determining a number of passengers on each floor within the evacuation zone; determining a number of elevator cars to send to each floor within the evacuation zone in response to the number of passengers on each floor, a capacity of each elevator car, and a location of the floor in reference to the first evacuation floor; and moving an elevator car to a first determined floor within the evacuation zone.

### BACKGROUND

The subject matter disclosed herein relates generally to the field of elevator systems, and specifically to a method and apparatus for operating an elevator system in a building evacuation.

Commonly, during an evacuation procedure occupants of a building are instructed to take the stairs and avoid the elevator systems. An efficient method of incorporating the elevators in to the overall evacuation procedures is desired.

### BRIEF SUMMARY

According to one embodiment, a method of operating an elevator building system is provided. The method including: receiving an evacuation call from a first evacuation floor; determining an evacuation zone surrounding the first evacuation floor; determining a number of passengers on each floor within the evacuation zone; determining a number of elevator cars to send to each floor within the evacuation zone in response to the number of passengers on each floor, a capacity of each elevator car, and a location of the floor in reference to the first evacuation floor; and moving an elevator car to a first determined floor within the evacuation zone.

In addition to one or more of the features described above, or as an alternative, further embodiments of the method may include: opening a door of the elevator car when the elevator car arrives at the first determined floor within the evacuation zone; monitoring, using a sensor system, a remaining capacity of the elevator car; and closing the door when at least one of the first selected period of time has passed and the remaining capacity of the elevator car is equal to a selected remaining capacity.

In addition to one or more of the features described above, or as an alternative, further embodiments of the method may include: moving the elevator car to a discharge floor when the remaining capacity of the elevator car is equal to the selected remaining capacity; opening the door of the elevator car when the elevator car arrives at the discharge floor; monitoring, using the sensor system, a remaining capacity of the elevator car; and closing the door remaining capacity indicates that the elevator car is empty.

In addition to one or more of the features described above, or as an alternative, further embodiments of the method may include: receiving an elevator call from a first call floor below the first determined floor; moving the elevator car to the first call floor when the remaining capacity of the elevator car is less than the selected remaining capacity and the first selected time period has passed; opening a door of the elevator car when the elevator car arrives at the first call floor; monitoring, using the sensor system, a remaining capacity of the elevator car; and closing the door when at least one of the second selected period of time has passed and the remaining capacity of the elevator car is equal to a second selected remaining capacity.

In addition to one or more of the features described above, or as an alternative, further embodiments of the method may include: moving the elevator car to a discharge floor when the remaining capacity of the elevator car is equal to the selected remaining capacity; opening the door of the elevator car when the elevator car arrives at the discharge floor; monitoring, using the sensor system, a remaining capacity of the elevator car; and closing the door when remaining capacity indicates that the elevator car is empty.

In addition to one or more of the features described above, or as an alternative, further embodiments of the method may include: updating the number of passengers on each floor within the evacuation zone in response to the remaining capacity of the elevator car when the elevator car arrived at the discharge floor; updating the number of elevator cars to send to each floor within the evacuation zone in response to the number of passengers on each floor, the capacity of each elevator car and the location of the floor in reference to the first evacuation floor; and moving the elevator car to a second determined floor within the evacuation zone.

In addition to one or more of the features described above, or as an alternative, further embodiments of the method may include: updating the number of passengers on each floor within the evacuation zone in response to the remaining capacity of the elevator car when the elevator car arrived at the discharge floor; updating the number of elevator cars to send to each floor within the evacuation zone in response to the number of passengers on each floor, the capacity of each elevator car and the location of the floor in reference to the first evacuation floor; and moving the elevator car to a second determined floor within the evacuation zone.

According to another embodiment, a control system of an elevator system is provided. The control system includes: a processor; and a memory comprising computer-executable instructions that, when executed by the processor, cause the processor to perform operations. The operations including: receiving an evacuation call from a first evacuation floor; determining an evacuation zone surrounding the first evacuation floor; determining a number of passengers on each floor within the evacuation zone; determining a number of elevator cars to send to each floor within the evacuation zone in response to the number of passengers on each floor, a capacity of each elevator car, and a location of the floor in reference to the first evacuation floor; and moving an elevator car to a first determined floor within the evacuation zone.

In addition to one or more of the features described above, or as an alternative, further embodiments of the control system may include that the operations further include: opening a door of the elevator car when the elevator car arrives at the first determined floor within the evacuation zone; monitoring, using a sensor system, a remaining capacity of the elevator car; and closing the door when at least one of the first selected period of time has passed and the remaining capacity of the elevator car is equal to a selected remaining capacity.

In addition to one or more of the features described above, or as an alternative, further embodiments of the control system may include that the operations further include: moving the elevator car to a discharge floor when the remaining capacity of the elevator car is equal to the selected remaining capacity; opening the door of the elevator car when the elevator car arrives at the discharge floor; monitoring, using the sensor system, a remaining capacity of the elevator car; and closing the door when the remaining capacity indicates that the elevator car is empty.

In addition to one or more of the features described above, or as an alternative, further embodiments of the control system may include that the operations further include: receiving an elevator call from a first call floor below the first determined floor; moving the elevator car to the first call floor when the remaining capacity of the elevator car is less than the selected remaining capacity and the first selected time period has passed; opening a door of the elevator car when the elevator car arrives at the first call floor; monitoring, using the sensor system, a remaining capacity of the elevator car; and closing the door when at least one of the second selected period of time has passed and the remaining capacity of the elevator car is equal to a selected remaining capacity.

In addition to one or more of the features described above, or as an alternative, further embodiments of the control system may include that the operations further include: moving the elevator car to a discharge floor when the remaining capacity of the elevator car is equal to the selected remaining capacity; opening the door of the elevator car when the elevator car arrives at the discharge floor; monitoring, using the sensor system, a remaining capacity of the elevator car; and closing the door when the remaining capacity indicates that the elevator car is empty.

In addition to one or more of the features described above, or as an alternative, further embodiments of the control system may include that the operations further include: updating the number of passengers on each floor within the evacuation zone in response to the remaining capacity of the elevator car when the elevator car arrived at the discharge floor; updating the number of elevator cars to send to each floor within the evacuation zone in response to the number of passengers on each floor, the capacity of each elevator car and the location of the floor in reference to the first evacuation floor; and moving the elevator car to a second determined floor within the evacuation zone.

In addition to one or more of the features described above, or as an alternative, further embodiments of the control system may include that the operations further include: updating the number of passengers on each floor within the evacuation zone in response to the remaining capacity of the elevator car when the elevator car arrived at the discharge floor; updating the number of elevator cars to send to each floor within the evacuation zone in response to the number of passengers on each floor, the capacity of each elevator car and the location of the floor in reference to the first evacuation floor; and moving the elevator car to a second determined floor within the evacuation zone.

According to another embodiment a computer program product tangibly embodied on a computer readable medium is provided. The computer program product including instructions that, when executed by a processor, cause the processor to perform operations including: receiving an evacuation call from a first evacuation floor; determining an evacuation zone surrounding the first evacuation floor; determining a number of passengers on each floor within the evacuation zone; determining a number of elevator cars to send to each floor within the evacuation zone in response to the number of passengers on each floor, a capacity of each elevator car, and a location of the floor in reference to the first evacuation floor; and moving an elevator car to a first determined floor within the evacuation zone.

In addition to one or more of the features described above, or as an alternative, further embodiments of the computer program may include that the operations further include: opening a door of the elevator car when the elevator car arrives at the first determined floor within the evacuation zone; monitoring, using a sensor system, a remaining capacity of the elevator car; and closing the door when at least one of the first selected period of time has passed and the remaining capacity of the elevator car is equal to a selected remaining capacity.

In addition to one or more of the features described above, or as an alternative, further embodiments of the computer program may include that the operations further include: moving the elevator car to a discharge floor when the remaining capacity of the elevator car is equal to the selected remaining capacity; opening the door of the elevator car when the elevator car arrives at the discharge floor; monitoring, using the sensor system, a remaining capacity of the elevator car; and closing the door when the remaining capacity indicates that the elevator car is empty.

In addition to one or more of the features described above, or as an alternative, further embodiments of the computer program may include that the operations further include: receiving an elevator call from a first call floor below the first determined floor; moving the elevator car to the first call floor when the remaining capacity of the elevator car is less than the selected remaining capacity and the first selected time period has passed; opening a door of the elevator car when the elevator car arrives at the first call floor; monitoring, using the sensor system, a remaining capacity of the elevator car; and closing the door when at least one of the second selected period of time has passed and the remaining capacity of the elevator car is equal to a selected remaining capacity.

In addition to one or more of the features described above, or as an alternative, further embodiments of the computer program may include that the operations further include: moving the elevator car to a discharge floor when the remaining capacity of the elevator car is equal to the selected remaining capacity; opening the door of the elevator car when the elevator car arrives at the discharge floor; monitoring, using the sensor system, a remaining capacity of the elevator car; and closing the door when the remaining capacity indicates that the elevator car is empty.

In addition to one or more of the features described above, or as an alternative, further embodiments of the computer program may include that the operations further include: updating the number of passengers on each floor within the evacuation zone in response to the remaining capacity of the elevator car when the elevator car arrived at the discharge floor; updating the number of elevator cars to send to each floor within the evacuation zone in response to the number of passengers on each floor, the capacity of each elevator car and the location of the floor in reference to the first evacuation floor; and moving the elevator car to a second determined floor within the evacuation zone.

Technical effects of embodiments of the present disclosure include using a control system to send a variable number of elevator cars to each floor within an evacuation zone.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The foregoing and other features, and advantages of the disclosure are apparent from the following detailed description taken in conjunction with the accompanying drawings in which like elements are numbered alike in the several FIGURES:

FIG. 1 illustrates a schematic view of an elevator system, in accordance with an embodiment of the disclosure;

FIG. 2 illustrates a schematic view of a building elevator system incorporating the elevator system of FIG. 1, in accordance with an embodiment of the disclosure; and

FIG. 3 is a flow chart of method of operating the elevator system of FIG. 1, in accordance with an embodiment of the disclosure.

### DETAILED DESCRIPTION

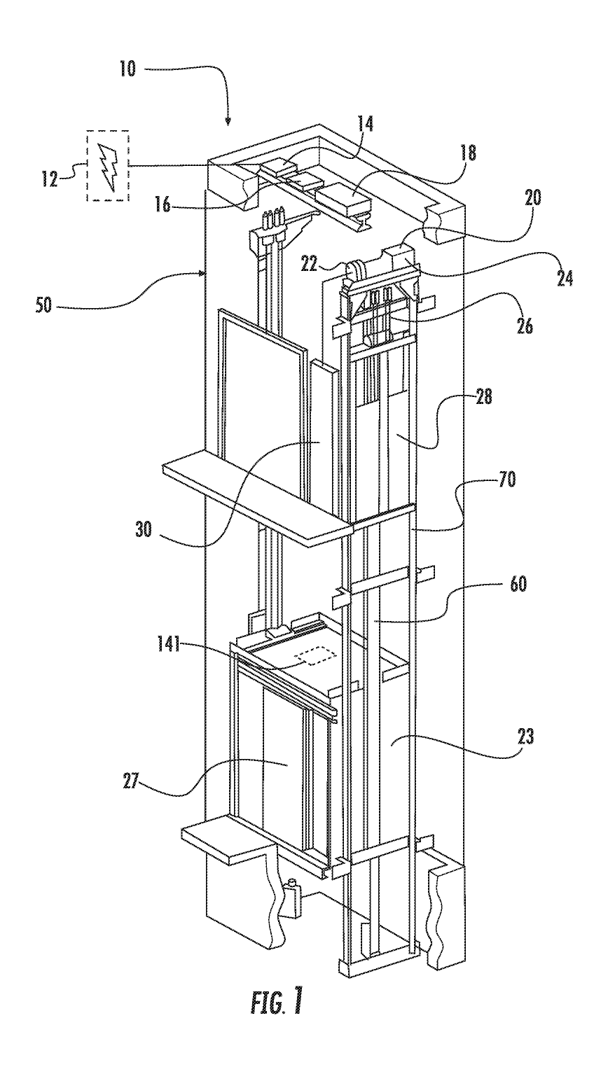

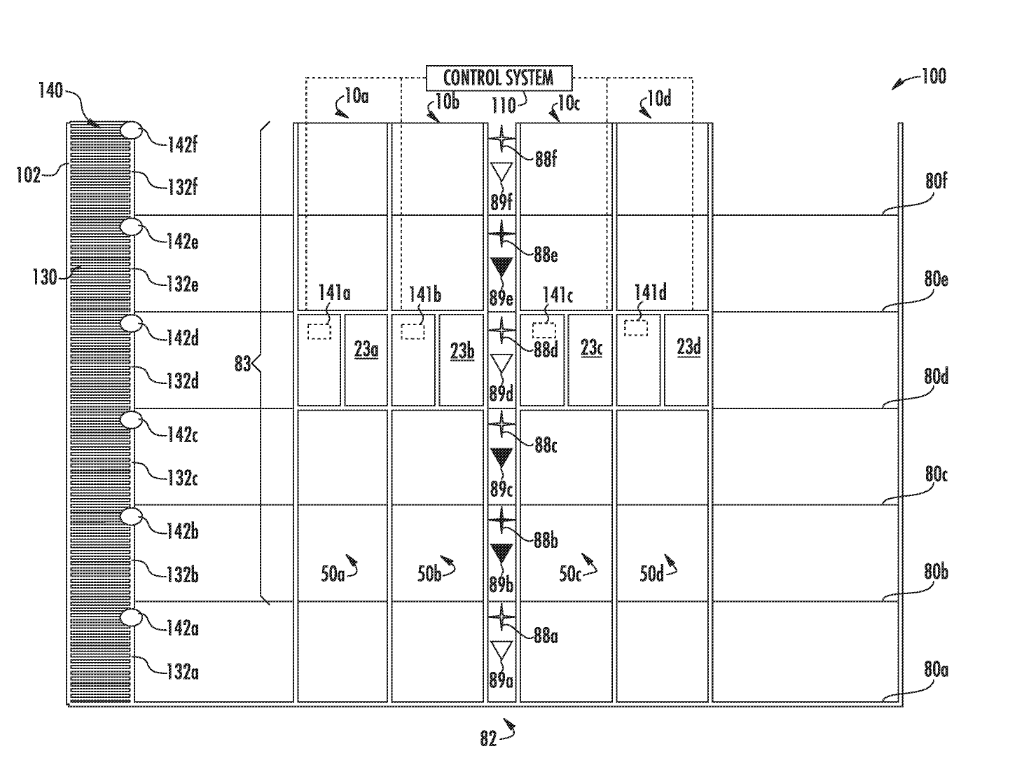

FIG. 1 shows a schematic view of an elevator system 10, in accordance with an embodiment of the disclosure. FIG. 2 shows schematic view of a building elevator system 100 incorporating the elevator system 10 of FIG. 1, in accordance with an embodiment of the disclosure. With reference to FIG. 1, the elevator system 10 includes an elevator car 23 configured to move vertically upward and downward within a hoistway 50 along a plurality of car guide rails 60. As seen in FIG. 1, the elevator car 23 includes a door 27 configured to open and close, allowing passengers (ex: occupants of the building 102) to enter and exit the elevator car 23. The elevator system 10 also includes a counterweight 28 operably connected to the elevator car 23 via a pulley system 26. The counterweight 28 is configured to move vertically upward and downward within the hoistway 50. The counterweight 28 moves in a direction generally opposite the movement of the elevator car 23, as is known in conventional elevator assemblies. Movement of the counterweight 28 is guided by counterweight guide rails 70 mounted within the hoistway 50.

The elevator system 10 also includes a power source 12. The power is provided from the power source 12 to a switch panel 14, which may include circuit breakers, meters, etc. From the switch panel 14, the power may be provided directly to the drive unit 20 through the controller 30 or to an internal power source charger 16, which converts AC power to direct current (DC) power to charge an internal power source 18 that requires charging. For instance, an internal power source 18 that requires charging may be a battery, capacitor, or any other type of power storage device known to one of ordinary skill in the art. Alternatively, the internal power source 18 may not require charging from the external power source 12 and may be a device such as, for example a gas powered generator, solar cells, hydroelectric generator, wind turbine generator or similar power generation device. The internal power source 18 may power various components of the elevator system 10 when an external power source is unavailable. The drive unit 20 drives a machine 22 to impart motion to the elevator car 23 via a traction sheave of the machine 22. The machine 22 also includes a brake 24 that can be activated to stop the machine 22 and elevator car 23. As will be appreciated by those of skill in the art, FIG. 1 depicts a machine room-less elevator system 10, however the embodiments disclosed herein may be incorporated with other elevator systems that are not machine room-less or that include any other known elevator configuration. In addition, elevator systems having more than one car in each elevator car shaft and/or ropeless elevator systems may also be used. In addition, the elevator car may include two or more compartments. In an embodiment, the elevator car may include two or more compartments.

The controller 30 is responsible for controlling the operation of the elevator system 10. The controller 30 may also determine a mode (motoring, regenerative, near balance) of the elevator car 23. The controller 30 may use the car direction and the weight distribution between the elevator car 23 and the counterweight 28 to determine the mode of the elevator car 23. The controller 30 may adjust the velocity of the elevator car 23 to reach a target floor. The controller 30 may include a processor and an associated memory. The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

The elevator system 10 includes a sensor system 141 configured to detect a remaining capacity in a particular elevator car 23. The remaining capacity allows the controller 30 to determine how much space is left in the elevator car 23. For instance, if the remaining capacity is equal to about zero there is no space left in the elevator car 23 to accept more passengers, whereas if the remaining capacity is greater than zero there may be space to accept more passengers in the elevator car 23. In the illustrated embodiments, the sensor system 141 is located in the elevator car 23. The sensor system 141 is in operative communication with the controller 30. The sensor system 141 may use a variety of sensing mechanisms such as, for example, a visual detection device, a weight detection device, a laser detection device, a door reversal monitoring device, a thermal image detection device, and a depth detection device. The visual detection device may be a camera that utilizes visual recognition to identify individual passengers and objects in the elevator car 23 and then determine remaining capacity. The weight detection device may be a scale to sense the amount of weight in an elevator car 23 and then determine the remaining capacity from the weight sensed. The laser detection device may detect how many passengers walk through a laser beam to determine the remaining capacity in the elevator car 23. Similarly, a door reversal monitoring device also detects passengers entering the car so as not to close the elevator door on a passenger and thus may be used to determine the remaining capacity. The thermal detection device may be an infrared or other heat sensing camera that utilizes detected temperature to identify individual passengers and objects in the elevator car 23 and then determine remaining capacity. The depth detection device may be a 2-D, 3-D or other depth/distance detecting camera that utilizes detected distance to an object and/or passenger to determine remaining capacity. As may be appreciated by one of skill in the art, in addition to the stated methods, additional methods may exist to sense remaining capacity and one or any combination of these methods may be used to determine remaining capacity in the elevator car 23.

FIG. 2 shows a building elevator system 100 incorporating a multiple elevator systems 10a-10d organized in an elevator bank 82 within a building 102. As may be appreciated by one of skill in the art, FIG. 2 only shows one elevator bank 82 for simplicity but more than one elevator banks may exist in the building 102. Each elevator system 10a-10d has an elevator car 23a-23d in an elevator hoistway 50a-50d. The building elevator system 100 is controlled by a system controller 110. The control system 110 is operably connected to the controller 30 of each elevator system 10a-10d. In one embodiment, each elevator system 10a-10d may share a single controller 30. The control system 110 is configured to the control and coordinate operation of multiple elevator systems 10a-10d. The control system 110 may be an electronic controller including a processor and an associated memory comprising computer-executable instructions that, when executed by the processor, cause the processor to perform various operations. The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium

The building 102 includes multiple floors 80a-80f, each having an elevator call button 89a-89f and an evacuation alarm 88a-88f. The elevator call button 89a-89f sends an elevator call to the control system 110. The elevator call button 89a-89f sends an elevator call to the control system 110. The elevator call button 89a-89f may be a push button and/or a touch screen and may be activated manually or automatically. For example, the elevator call button 89a-89f may be activated by a building occupant pushing the elevator call button 89a-89f. The elevator call button 89a-89f may also be activated voice recognition or a passenger detection mechanism in the hallway, such as, for example a weight sensing device, a visual recognition device, and a laser detection device. The evacuation alarm 88a-88f may be activated or deactivated either manually or through automated fire alarm system. If the evacuation alarm 88a-88f is activated, an evacuation call is sent to the control system 110 indicating the respective floor 80a-80f where the evacuation alarm 88a-88f was activated. In the example of FIG. 2, an evacuation alarm 88d is activated first on floor 80d and a second evacuation alarm 88b is later activated on floor 80b. The evacuation alarm 88a, 88c, 88e, 88f is not activated on floors 88a, 88c, 88e, and 88f. The first floor to activate an evacuation alarm may be known as the first evacuation floor. In the example of FIG. 2, the first evacuation floor is floor 80d. The second evacuation floor to activate an evacuation alarm may be known as the second evacuation floor and so on.

The first evacuation floor may be surrounded by padding floors, which are floors that are considered at increased risk due to their proximity to the evacuation floor and thus should also be evacuated. In the example of FIG. 2, the padding floors for the first evacuation floor are floors 80b, 80c, 80e, and 80f. The padding floors may include floors that are a selected number of floors away from the first evacuation floor. In one embodiment, the padding floors may include any number of floors on either side of an evacuation floor. For example, in one embodiment, the padding floors may include the floor immediately below the evacuation floor and the three floors immediately above the evacuation floor. In another example, in one embodiment, the padding floors may include the two floors immediately below the evacuation floor and the two floors immediately above the evacuation floor. The first evacuation floor and the padding floors make up an evacuation zone 83. In the example of FIG. 2, the evacuation zone is composed of floors 80b-80f. In an example, the control system 110 may prioritize the first evacuation floor for evacuation, the evacuation zone 83 for evacuation and/or higher floors for evacuation over lower floors.

In one embodiment, there may be more than one evacuation floor. For example, after the first evacuation floor activates an evacuation alarm, a second evacuation floor may also activate an evacuation alarm. In the example of FIG. 2, the second evacuation floor is floor 80b. In one embodiment, there may be any number of evacuation floors. Although in the embodiment of FIG. 2 the second evacuation floor is contiguous to the padding floors of the first evacuation floor, the second evacuation floor and any subsequent evacuation floors may be located anywhere within the building. The building also includes a discharge floor, which is a floor where occupants can evacuate the building 102. For example, in one embodiment the discharge floor may be a ground floor. In one embodiment, the discharge floor may be any floor from which occupants and safely evacuate the building. In the example of FIG. 2, the discharge floor is floor 80a. The building may also include a stairwell 130 as seen in FIG. 2.

The control system 110 is configured to determine how many passengers are on a particular floor 80a-80f. The control system 110 may determine how many passengers are on a particular floor 80a-80f using an executable algorithm and/or a look up table that may be stored within the memory of the controller 30. The look up table may contain predicted number for how many passengers are on each floor 80 on a particular date at a particular time. For example, the predicted number of passenger may be more for a day during the work week then a day on the weekend. In one embodiment, this data may be provided into the system by a building manager, tenants, or businesses located in the building 102. For example, the data could include a number of employees employed at a business on a particular floor of the building 102 and the expected working hours and days of those employees. In one embodiment, expected working hours and days could be entered for each employee. The data may be input when the system is first commissioned or updated at periodic intervals as desired.

The control system 110 may also determine how many passengers are on a particular floor 80a-80f using a building integrated personnel sensing system 140 composed a plurality of sensors throughout the building 102 configured to detect a number of passengers on each floor 80a-80f. The building integrated personnel sensing system 140 may count the number of passengers entering and exiting each floor 80a-80f using a stairwell door sensors 142a-142f and also the sensor systems 141a, 141b. In one embodiment, the number of personnel on a particular floor may be determined by using security access control data (and corresponding floor access permissions/information) as personnel scan their credentials as they enter the building.

The stairwell door sensor 142a-142f counts the number of passengers entering and exiting the respective stairwell door 132a-132f. The stairwell door sensor 142a-142f may use a variety of sensing mechanisms such as, for example, a visual detection device, a weight detection device, a laser detection device, a thermal image detection device, and a depth detection device. The visual detection device may be a camera that utilizes visual recognition to identify and count individual passengers entering and exiting a particular floor 80a-80f from the stairwell 130. The weight detection device may be a scale to sense the amount of weight in an area proximate the stairwell door 132a-132f and then determine the number of passengers entering and exiting the particular floor 80a-80f from the weight sensed. The laser detection device may detect how many passengers walk through a laser beam located proximate the stairwell door 132a-132f to determine the number of passengers entering and exiting a floor 80a-80f. The thermal detection device may be an infrared or other heat sensing camera that utilizes detected temperature to identify how many passengers are located proximate the stairwell door 132a-132f to determine the number of passengers entering and exiting a floor 80a-80f. The depth detection device may be a 2-D, 3-D or other depth/distance detecting camera that utilizes detected distance to a passenger to determine how many passengers are located proximate the stairwell door 132a-132f to determine the number of passengers entering and exiting a floor 80a-80f. The stairwell door sensor 142a-142f interacts with the sensor systems 141a, 141b to determine the number of passengers on each floor 80a-80f. As may be appreciated by one of skill in the art, in addition to the stated methods, additional methods may exist to sense passengers and one or any combination of these methods may be used to determine the number of passengers entering and exiting a floor 80a-80f.

Advantageously, by tracking the number of passengers entering or exiting a floor 80a-80f, when an evacuation call is received from a first evacuation floor 84, the control system 110 could quickly identify the floors 80a-80f with the most passengers and allocate elevator cars 23a-23d accordingly.

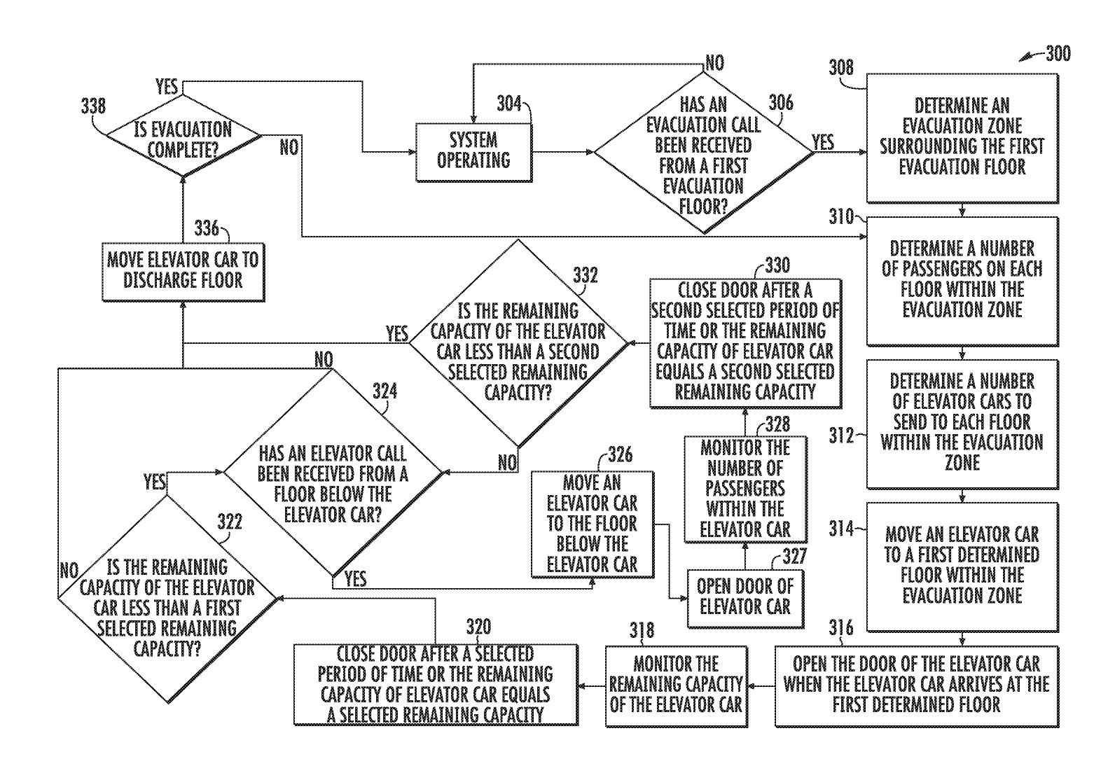

Referring now to FIG. 3, while referencing components of FIGS. 1 and 2. FIG. 3 shows a flow chart of method 300 of operating the building elevator system 100 of FIG. 2, in accordance with an embodiment of the disclosure. At block 304, the elevator building system 100 is under normal operation. At block 306, the control system 110 checks whether it has received an evacuation call from the first evacuation floor. At block 306, if the controller 30 has received an evacuation call from the first evacuation floor then the controller 30 determines an evacuation zone 83 surrounding the first evacuation floor at block 308. In one example, as illustrated in FIG. 2, the evacuation zone may be composes of floors 80b-80f. As mentioned above, the evacuation zone 83 includes the first evacuation floor and a selected number of padding floors around the first evacuation floor. At block 310, the control system 110 determines a number of passengers on each floor within the evacuation zone 83. As mentioned above, the number of passengers on each floor within the evacuation zone 83 may be determined by at least one of an executable algorithm, look up table, and a building integrated personnel sensing system 140. Next at block 312, the control system 110 determines a number of elevator cars 23 to send to each floor within the evacuation zone 83 in response to the number of passengers on each floor, the capacity of each elevator car and the location of the floor in reference to the first evacuation floor. The control system 110 may give priority to the first evacuation floor and those floors closest to the first evacuation floor, which is why the location of the floor in reference to the first evacuation floor is considered. Further, floors may be evacuated in order of elevations, so the highest floor in the evacuation zone 83 may be evacuated before the lowest floor in the evacuation zone 83. Each elevator car is thus assigned a determined floor at block 312.

At block 314, the control system 110 moves the elevator car 23 to a first determined floor within the evacuation zone 83. At block 316, the control system 110 opens the door 27 of the elevator car 23 when the elevator car 23 arrives at the first determined floor. Opening the door 27 allows passengers to enter the elevator car 23. At block 318, the sensor system 141 monitors the remaining capacity of the elevator car at block 318. The control system 110 closes the door 27 after a first selected period of time at block 320 or until the remaining capacity of the elevator car equals a selected remaining capacity. The first selected period of time may be the time required for passengers to enter the elevator car 23, such as, for example, thirty seconds. The selected remaining capacity may be a maximum capacity for the elevator car 23. At block 322, the control system 110 checks whether the remaining capacity in the elevator car 23 is greater than zero. At block 322, if the remaining capacity in the elevator car 23 is not greater than zero, then the control system 110 and moves the elevator car 23 to the discharge floor at block 336. At block 322, if the remaining capacity in the elevator car 23 greater than zero after the first selected time period, then the control system 110 checks whether an elevator call has been received from a floor below the elevator car 23 at block 324.

At block 324, if an elevator call has not been received from a floor below the elevator car 23 then the control system 110 moves the elevator car 23 to the discharge floor at block 336. At block 324, if an elevator call has been received from a floor below the elevator car 23 then the control system 110 moves the elevator car 23 to the floor below the elevator car 23 that sent the elevator call at block 326. Once at the floor, the control system 110 opens the door 27 of the elevator car 23 to allow passengers to enter at block 327. At block 328, the sensor system 141 monitors the remaining capacity of the elevator car 23. At block 330, the control system holds the door 27 open for a second selected period of time or until the remaining capacity of the elevator car equals a second selected remaining capacity. The second selected period of time may be a time required to fill the remaining capacity of the elevator car 23.

At block 332, the control system 110 checks whether the remaining capacity of the elevator car 23 is greater than zero. At block 332, if the remaining capacity of the elevator car 23 is greater than zero then the method 300 will move back to block 324 to check whether an elevator call was received from a floor below the elevator car 23. At block 332, if the remaining capacity of the elevator car 23 is not greater than zero then control system 110 will move the elevator car 23 to the discharge floor at block 336. Once the elevator car 23 is emptied at the discharge floor then the control system 110 checks whether the evacuation is complete at block 338. For example, the evacuation may be complete when there are no passengers left in the evacuation zone 83. At block 338, if the evacuation is complete then the building elevator system 100 will return back to normal operation at block 304. At block 338, if the evacuation is not complete then the building elevator system 100 will return back to block 310 to update the number of passengers on each floor within the evacuation zone 83. When updating the number of passengers, the control system 110 takes into account passengers already taken to the discharge floor by the elevator cars 23.

While the above description has described the flow process of FIG. 3 in a particular order, it should be appreciated that unless otherwise specifically required in the attached claims that the ordering of the steps may be varied.

As described above, embodiments can be in the form of processor-implemented processes and devices for practicing those processes, such as processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The terminology used herein is for the purpose of describing particular embodiments only and is not intended to be limiting. While the description has been presented for purposes of illustration and description, it is not intended to be exhaustive or limited to embodiments in the form disclosed. Many modifications, variations, alterations, substitutions or equivalent arrangement not hereto described will be apparent to those of ordinary skill in the art without departing from the scope of the disclosure. Additionally, while the various embodiments have been described, it is to be understood that aspects may include only some of the described embodiments. Accordingly, the disclosure is not to be seen as limited by the foregoing description, but is only limited by the scope of the appended claims.

What is claimed is:

1. A method of operating an elevator building system, the method comprising:
receiving an evacuation call from a first evacuation floor;
determining an evacuation zone surrounding the first evacuation floor;
determining a number of passengers on each floor within the evacuation zone;
determining a number of elevator cars to send to each floor within the evacuation zone in response to the number of passengers on each floor, a capacity of each elevator car, and a location of the floor in reference to the first evacuation floor; and
moving an elevator car to a first determined floor within the evacuation zone.

2. The method of claim 1, further comprising:
opening a door of the elevator car when the elevator car arrives at the first determined floor within the evacuation zone;
monitoring, using a sensor system, a remaining capacity of the elevator car; and
closing the door when at least one of the first selected period of time has passed and the remaining capacity of the elevator car is equal to a selected remaining capacity.

3. The method of claim 2, further comprising:
moving the elevator car to a discharge floor when the remaining capacity of the elevator car is equal to the selected remaining capacity;
opening the door of the elevator car when the elevator car arrives at the discharge floor;
monitoring, using the sensor system, a remaining capacity of the elevator car; and
closing the door remaining capacity indicates that the elevator car is empty.

4. The method of claim 2, further comprising:
receiving an elevator call from a first call floor below the first determined floor;
moving the elevator car to the first call floor when the remaining capacity of the elevator car is less than the selected remaining capacity and the first selected time period has passed;
opening a door of the elevator car when the elevator car arrives at the first call floor;
monitoring, using the sensor system, a remaining capacity of the elevator car; and
closing the door when at least one of the second selected period of time has passed and the remaining capacity of the elevator car is equal to a second selected remaining capacity.

5. The method of claim 4, further comprising:
moving the elevator car to a discharge floor when the remaining capacity of the elevator car is equal to the selected remaining capacity;
opening the door of the elevator car when the elevator car arrives at the discharge floor;
monitoring, using the sensor system, a remaining capacity of the elevator car; and
closing the door when remaining capacity indicates that the elevator car is empty.

6. The method of claim 3, further comprising:
updating the number of passengers on each floor within the evacuation zone in response to the remaining capacity of the elevator car when the elevator car arrived at the discharge floor;
updating the number of elevator cars to send to each floor within the evacuation zone in response to the number of passengers on each floor, the capacity of each elevator car and the location of the floor in reference to the first evacuation floor; and moving the elevator car to a second determined floor within the evacuation zone.

7. The method of claim 5, further comprising:
updating the number of passengers on each floor within the evacuation zone in response to the remaining capacity of the elevator car when the elevator car arrived at the discharge floor;
updating the number of elevator cars to send to each floor within the evacuation zone in response to the number of passengers on each floor, the capacity of each elevator car and the location of the floor in reference to the first evacuation floor; and
moving the elevator car to a second determined floor within the evacuation zone.

8. A control system of an elevator system comprising:
a processor; and
a memory comprising computer-executable instructions that, when executed by the processor, cause the processor to perform operations, the operations comprising:
receiving an evacuation call from a first evacuation floor;
determining an evacuation zone surrounding the first evacuation floor;
determining a number of passengers on each floor within the evacuation zone;
determining a number of elevator cars to send to each floor within the evacuation zone in response to the number of passengers on each floor, a capacity of each elevator car, and a location of the floor in reference to the first evacuation floor; and
moving an elevator car to a first determined floor within the evacuation zone.

9. The control system of claim 8, wherein the operations further comprise:
opening a door of the elevator car when the elevator car arrives at the first determined floor within the evacuation zone;
monitoring, using a sensor system, a remaining capacity of the elevator car; and
closing the door when at least one of the first selected period of time has passed and the remaining capacity of the elevator car is equal to a selected remaining capacity.

10. The control system of claim 9, wherein the operations further comprise:
moving the elevator car to a discharge floor when the remaining capacity of the elevator car is equal to the selected remaining capacity;
opening the door of the elevator car when the elevator car arrives at the discharge floor;
monitoring, using the sensor system, a remaining capacity of the elevator car; and
closing the door when the remaining capacity indicates that the elevator car is empty.

11. The control system of claim 9, wherein the operations further comprise:
receiving an elevator call from a first call floor below the first determined floor;
moving the elevator car to the first call floor when the remaining capacity of the elevator car is less than the selected remaining capacity and the first selected time period has passed;
opening a door of the elevator car when the elevator car arrives at the first call floor;
monitoring, using the sensor system, a remaining capacity of the elevator car; and
closing the door when at least one of the second selected period of time has passed and the remaining capacity of the elevator car is equal to a selected remaining capacity.

12. The control system of claim 11, wherein the operations further comprise:
moving the elevator car to a discharge floor when the remaining capacity of the elevator car is equal to the selected remaining capacity;
opening the door of the elevator car when the elevator car arrives at the discharge floor;
monitoring, using the sensor system, a remaining capacity of the elevator car; and
closing the door when the remaining capacity indicates that the elevator car is empty.

13. The control system of claim 10, wherein the operations further comprise:
updating the number of passengers on each floor within the evacuation zone in response to the remaining capacity of the elevator car when the elevator car arrived at the discharge floor;
updating the number of elevator cars to send to each floor within the evacuation zone in response to the number of passengers on each floor, the capacity of each elevator car and the location of the floor in reference to the first evacuation floor; and
moving the elevator car to a second determined floor within the evacuation zone.

14. The control system of claim 12, wherein the operations further comprise:
updating the number of passengers on each floor within the evacuation zone in response to the remaining capacity of the elevator car when the elevator car arrived at the discharge floor;
updating the number of elevator cars to send to each floor within the evacuation zone in response to the number of passengers on each floor, the capacity of each elevator car and the location of the floor in reference to the first evacuation floor; and
moving the elevator car to a second determined floor within the evacuation zone.

15. A computer program product tangibly embodied on a computer readable medium, the computer program product including instructions that, when executed by a processor, cause the processor to perform operations comprising:
receiving an evacuation call from a first evacuation floor;
determining an evacuation zone surrounding the first evacuation floor;
determining a number of passengers on each floor within the evacuation zone;
determining a number of elevator cars to send to each floor within the evacuation zone in response to the number of passengers on each floor, a capacity of each elevator car, and a location of the floor in reference to the first evacuation floor; and
moving an elevator car to a first determined floor within the evacuation zone.

16. The computer program of claim 15, wherein the operations further comprise:
opening a door of the elevator car when the elevator car arrives at the first determined floor within the evacuation zone;
monitoring, using a sensor system, a remaining capacity of the elevator car; and
closing the door when at least one of the first selected period of time has passed and the remaining capacity of the elevator car is equal to a selected remaining capacity.

17. The computer program of claim 16, wherein the operations further comprise:
moving the elevator car to a discharge floor when the remaining capacity of the elevator car is equal to the selected remaining capacity;
opening the door of the elevator car when the elevator car arrives at the discharge floor;
monitoring, using the sensor system, a remaining capacity of the elevator car; and
closing the door when the remaining capacity indicates that the elevator car is empty.

18. The computer program of claim 16, wherein the operations further comprise:
receiving an elevator call from a first call floor below the first determined floor;
moving the elevator car to the first call floor when the remaining capacity of the elevator car is less than the selected remaining capacity and the first selected time period has passed;
opening a door of the elevator car when the elevator car arrives at the first call floor;
monitoring, using the sensor system, a remaining capacity of the elevator car; and
closing the door when at least one of the second selected period of time has passed and the remaining capacity of the elevator car is equal to a selected remaining capacity.

19. The computer program of claim 18, wherein the operations further comprise:
moving the elevator car to a discharge floor when the remaining capacity of the elevator car is equal to the selected remaining capacity;
opening the door of the elevator car when the elevator car arrives at the discharge floor;
monitoring, using the sensor system, a remaining capacity of the elevator car; and
closing the door when the remaining capacity indicates that the elevator car is empty.

20. The computer program of claim 17, wherein the operations further comprise:
updating the number of passengers on each floor within the evacuation zone in response to the remaining capacity of the elevator car when the elevator car arrived at the discharge floor;
updating the number of elevator cars to send to each floor within the evacuation zone in response to the number of passengers on each floor, the capacity of each elevator car and the location of the floor in reference to the first evacuation floor; and
moving the elevator car to a second determined floor within the evacuation zone.
